(19) United States
(12) Patent Application Publication
(10) Pub. No.: US 2002/0144267 A1
(43) Pub. Date: Oct. 3, 2002

(54) Dynamic television channel creation

(75) Inventors: Srinivas Gutta, Buchanan, NY (US); Kaushal Kurapati, Yorktown Heighs, NY (US); Miroslav Trajkovic, Ossining, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/821,059

(22) Filed: Mar. 29, 2001

(51) Int. Cl. H04N 5/445

(52) U.S. Cl. 725/46

(57) ABSTRACT

A system for providing an interactive interface, wherein a television viewer can create a personal television channel. Such a system has the advantage of eliminating the need to peruse or surf television guides for the programs that an individual television viewer wants to watch. The personal channel contains all of the preferential programs selectable by the television viewer.

### FIELD OF THE INVENTION

The present invention relates to systems and methods of selecting television programs via a television viewing interface and, more particularly, to a system and method of creating a dynamic, interactive television channel for a television viewer.

### BACKGROUND OF THE INVENTION

The present invention relates to systems that employ electronic program guides (EPGs) to assist media viewers in managing a large number of program choices. More specifically, the invention relates to creating a personal channel for the television viewer that will make program selection more facile.

A common element among conventional electronic program guide systems is their ability to display listings of programs for many available channels. The listings may be generated locally and displayed interactively. The listings are commonly arranged in a grid, with each row representing a particular broadcast or cable channel, such as ABC, PBS, or ESPN, and each column of the grid representing a particular time slot, such as 4:00 p.m. to 4:30 p.m. Multiple rows and multiple columns can be displayed on the screen simultaneously. The various scheduled programs or shows are arranged within the rows and columns, indicating the channels and times at which they can be found. The grid can be scrolled vertically (tilted) so that a viewer can scan through different channels within a given interval of time. The grid may also be scrolled horizontally (panned) to change the time interval displayed.

Program data can be received as a set of data records by a cable system or telephone line. Each available program may have a single corresponding data record containing information about the program, such as: its channel, its starting and ending times, its title, names of starring actors, open or closed-captioning, and stereo availability. In some instances, the data may comprise a brief description of the program. It is not difficult to format this type of grid.

The data spanning a period (e.g., two weeks) are typically formatted once at the server (e.g., the cable system's head-end), and then broadcast repeatedly and continuously to the homes served by the cable system. Alternatively, the data may be downloaded via phone lines or other networks, either on-demand or pursuant to a predetermined schedule.

An EPG system can run on a device with a viewer interface, which can be a set-top box (STB), a general purpose computer, an embedded system, a controller within the television, or the server of a communications network or Internet server. The viewer interface device is connected to the TV to generate displays and receive input from the viewer. The user interface device may retrieve appropriate information from a stored database, in the user interface device or elsewhere, regarding the programming information that must be presented for the new row or column, when scrolling to a new column or row. The user interface device may retrieve appropriate information from a stored database in the user interface device or elsewhere, regarding the programming information to be presented for the new row or column. For instance, when scrolling to a new column, programs falling within a new time slot need be displayed. Electronic program guides promise to make the task of choosing from among the myriad television programs more manageable.

EPGs build a viewer preference database that uses the preference data to make suggestions. It filters current or future programming information in order to simplify the selection process. For example, the system can record a program without a specific request from the viewer, or it can highlight choices that it recommends.

A passive type of device builds the preference database by extracting a model of the viewing behavior of the individual. It then uses the model to make predictions about what the viewer would prefer to watch in the future. This extraction process can follow simple algorithms, such as identifying apparent favorites by detecting repeated requests for the same item. It can also use a more sophisticated decision-tree technique having a large number of inputs (degrees of freedom). Such models, generally speaking, detect patterns in the viewer interaction behavior (i.e., interaction with the viewer-interface (UI) for making selections).

One fairly robust technique for extracting useful information from the viewer watching pattern is to generate a table of feature-value counts. An example of this is the “time of day”; a corresponding value could be “morning.” The counts of the feature-values characterizing that choice are incremented when a choice is made. Usually, a given choice will have many feature-values.

A set of negative choices may also be generated by selecting a subset of shows (optionally at the same time) from which the choice was discriminated. Their respective feature-value counts are decremented (or a count for shows not watched, incremented) . This data is sent to a Bayesian predictor that uses the counts as weights. Feature-counts characterize candidates and predict the probability that that candidate will be preferred. This type of profiling mechanism is described in U.S. patent application Ser. No. 09/498,271, filed Feb. 4, 2000 for BAYESIAN TV SHOW RECOMMENDER, the entirety of which is hereby incorporated by reference as if fully set forth herein. A rule-based recommender in this same class of systems, which build profiles passively from observations of viewer behavior, is also described in the PCT application, WO 99/01984 published Jan. 14, 1999 for INTELLIGENT ELECTRONIC PROGRAM GUIDE.

An EP application (EP 0854645A2) describes a system that enables a viewer to enter generic preferences, such as a preferred program category (e.g., a sitcom, dramatic series, old movie, etc.). The application also describes preference templates in which preference profiles can be selected; for example, one for children aged 10-12, another for teenage girls, another for airplane hobbyists, etc.

A third type of system allows a viewer to rank programs in some fashion. Currently, TIVO® permits a viewer to rate a show as three thumbs up, for example, or three thumbs down.

A PCT application No. WO 97/4924, entitled SYSTEM AND METHOD FOR USING TELEVISION SCHEDULE INFORMATION, is an example of the third type of system. It describes a technique in which a viewer can navigate through an electronic program guide displayed in the usual grid fashion and select various programs. At each point, the viewer may be performing any one of a number of described tasks, including selecting a program for recording or viewing, scheduling a reminder to watch a program, and/or selecting a program to designate as a favorite. Designating a program as a favorite is presumably for the purpose of implementing a fixed rule, such as: “Always display the option of watching this show”, or to implement a recurring reminder.

The present invention contemplates a system that presents the television viewer with the ability to create a personal channel with an interactive interface. Such a system has the advantage of eliminating the need to surf television guides for the programs one wants to watch, and having to program a VCR to record a particular program. The personal channel contains all of the preferential programs selected for that viewer. The personal channel content can be created in a number of ways, described hereinbelow.

First, television viewers knowing exactly what they want to watch can specify particular programs (e.g., “Friends” on WPIX from 7:00 to 7:30 PM, followed by “Ally McBeal” on WCBS from 7:30 to 8:00 PM, etc.).

Television viewers who require assisted viewing selection can use a profile generated in several ways: through explicit information provided by the viewer; through passive information, wherein the system observes what the viewer is watching and automatically develops a profile; through collaborative filtering by observing what programs others in the household have developed in their personal channel (such a system assumes that a back channel exists, and that a server contains programs displayed in the other personal channels); and through a combination of all of the above.

The invention also contemplates creating a split screen, or picture-in-picture (PIP) on the viewer's personal channel, for those instances where more than one preferred program is scheduled for the same time slot.

In another embodiment of the present invention, the personal channel can be equipped with voice recognition, so that the input of information and the selection of viewing preferences can be expedited.

### DISCUSSION OF THE RELATED ART

In U.S. Pat. No. 5,534,911, a system is described that creates a virtual personal channel for a television viewer. The viewer creates a personal channel by answering specific questions, such as providing a rating to specific programs, or providing a particular preferred genre of programs. The created personal channel comprises a set of programs depicting the channel and the time that a particular program will be available. A computer switches a video receiver to a physical channel on which a program preference is most likely transmitted. The program of the day or the week is recorded, and can also be presented as a current program.

In Patent Disclosure No. WO-0040026, a system is illustrated wherein a multiplicity of personal channels is created. Each personal channel contains a particular genre of program. The television viewer surfs these personal channels, rather than surfing particular programs in a television guide.

### SUMMARY OF THE INVENTION

The invention features a system wherein a television viewer can create a personal television channel. Such a system has the advantage of eliminating the need to peruse television guides for the programs one wants to watch. The personal channel contains all of the preferential programs selected for that viewer. The personal channel content can be created in a number of ways. For example, television viewers knowing exactly what they want to watch can specify particular programs (e.g., “Friends” on WPIX from 7:00 to 7:30 PM, followed by “Ally McBeal” on WCBS from 7:30 to 8:00 PM, etc.).

Television viewers who require assisted viewing selection can use a profile generated in several ways: (i) through explicit information provided by the viewer; (ii) through passive information wherein the system observes what the viewer is watching and automatically develops a profile; (iii) through collaborative filtering by observing what programs others in the household have developed in their personal channel (such a system assumes that a back channel exists, and a server contains programs displayed in the other personal channels); and (iv) through a combination of all of the above.

The television viewer selects the personal channel, by choosing “personal channel” on a remote device, so keyed for this activity. Thereafter, the list of programs available for the viewer is displayed upon the television screen. The viewer then selects a particular program that is intended for watching or recording. The tuner of the television will automatically be programmed to bring the program for viewing upon the screen, or a timer will automatically program the system to record the show on a VCR. The automatic recording of the program relieves the burden of having to program the VCR to record a program.

In another embodiment of this invention, the personal channel can be provided with a split screen or PIP, when the viewer wants to view more than one program that is scheduled for the same time slot.

In another embodiment of the present invention, the personal channel can be equipped with voice recognition, so that the input of information and the selection of viewing preferences can be expedited.

It is an object of the present invention to provide an interactive interface for television viewing comprising a personal television channel displaying a list of select television programs.

It is another object of this invention to provide a personal channel for each viewer in a household, wherein all of their favorite programs will be listed for their own personal enjoyment.

### BRIEF DESCRIPTION OF THE DRAWINGS

A complete understanding of the present invention may be obtained by reference to the accompanying drawings, when considered in conjunction with the subsequent detailed description, in which:

FIG. 1 shows a front view of a typical television/monitor displaying an EPG with a computer to generate the EPG display and an interaction interface suitable for use with embodiments of the invention;

FIG. 2 depicts a front view of a hand held, remote control wand for use with the television/monitor and computer illustrated in FIG. 1; and

FIG. 3 shows an enlarged front view of the television/monitor screen depicted in FIG. 1.

### DETAILED DESCRIPTION OF THE PREFERRED EMBODIMENTS

Generally speaking, the invention features a system for providing an interactive interface, wherein a television viewer can create a personal television channel. Such a system has the advantage of eliminating the need to surf television guides for the programs that an individual television viewer wants to watch. The personal channel contains all of the preferential programs selectable by the television viewer.

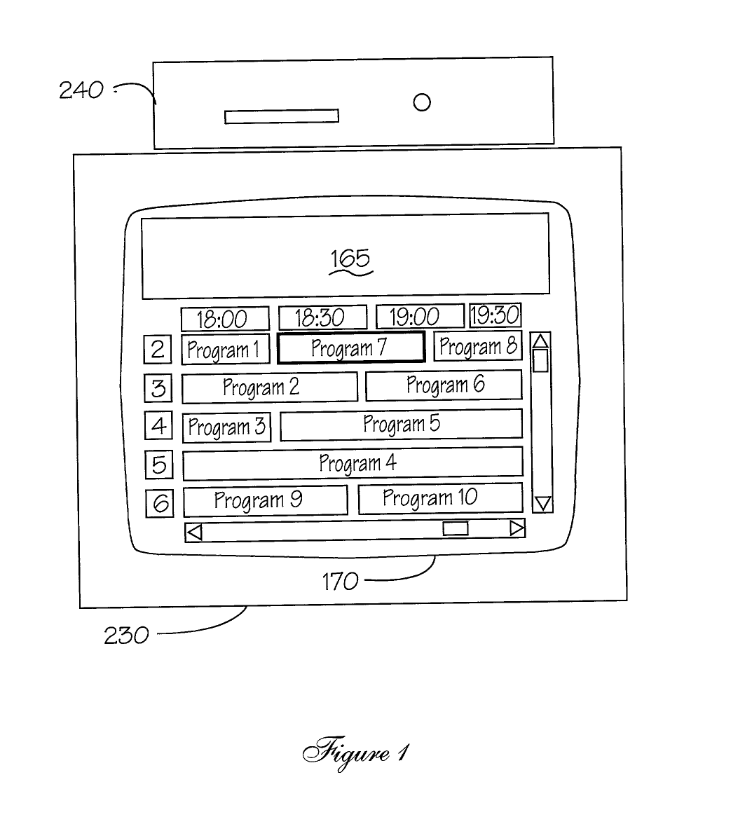

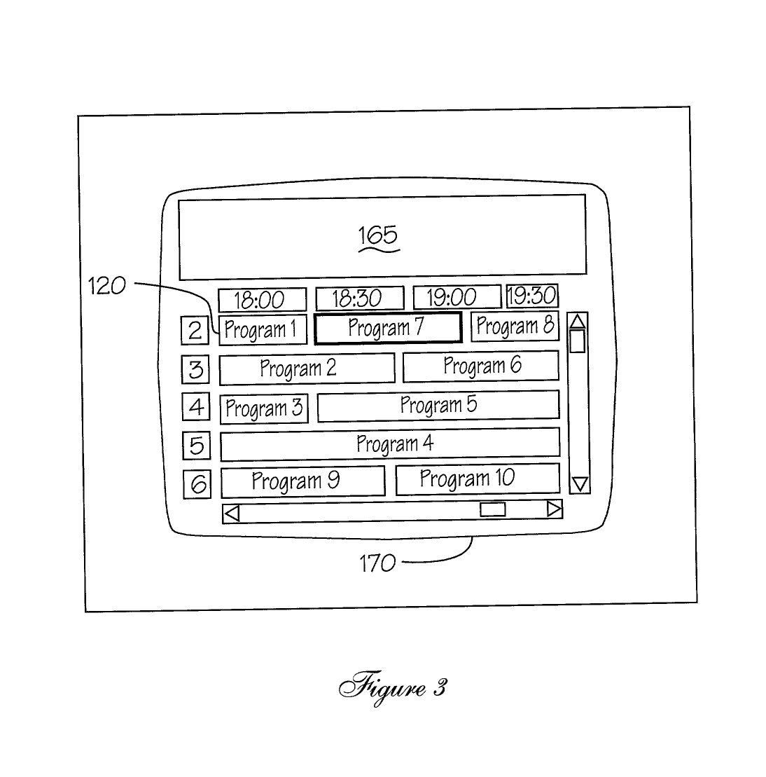

Now referring to FIG. 1, a television/monitor 230 is shown having a screen 170 for displaying the personal channel of the individual television viewer. The television/monitor 230 is under the control of a computer/VCR unit 240. The personal channel created for an individual television viewer is viewable by selecting the channels numbered 2 through 6, after simultaneously depressing both the star (*) and pound (#) keys 238 and 237, respectively. The personal channel No. 1 has already been selected, giving rise to the current display, seen in greater detail in FIG. 3.

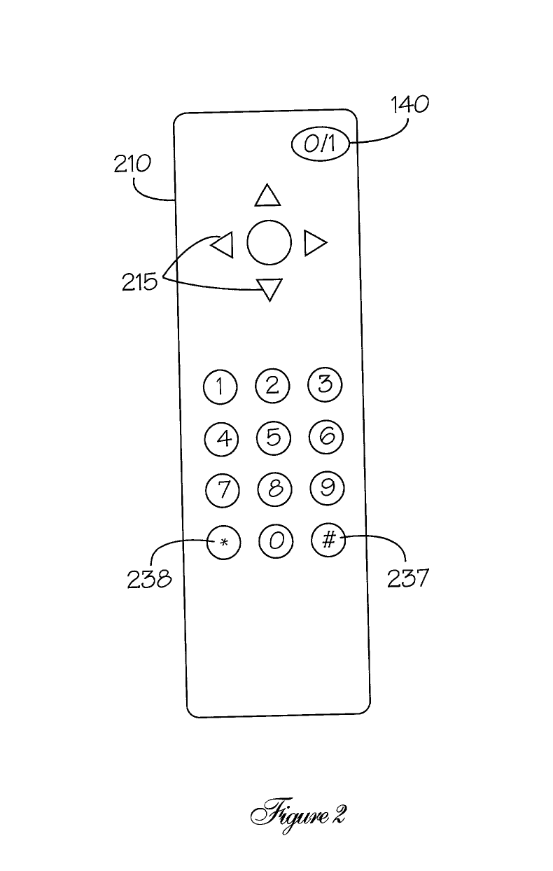

The hand held remote control wand 210, illustrated in FIG. 2, is used to make the selections on screen 170 of television/monitor 230. The current screen 170 depicts a multiplicity of program nos. 1 through 10 that are available in the current time slots of 18:00 to 19:30 hours, military time. Selecting any particular program, such as program No. 7, for example, provides a description of that program to appear in the upper window 165.

Referring to FIG. 2, the hand held remote control wand 210 is shown having cursor arrows 215. These cursor arrows 215 are used to scroll up and down, and from side to side, on the screen 170. The star (*) button 238 can be used to invoke the personal channel mode on screen 170. The pound (#) button 237 can be used to program the computer/VCR 240 to record any particular program selected by the viewer. The wand 210 also comprises a button 140 to provide PIP or split screen capability.

The personal channel content can be created in a number of ways. For example, television viewers knowing exactly what they want to watch can specify particular programs (e.g., “Friends” on WPIX from 7:00 to 7:30 PM, followed by “Ally McBeal” on WCBS from 7:30 to 8:00 PM, etc.), to be displayed on the interface of their personal channel.

Television viewers who require assisted viewing selection can use a profile generated in several ways: (i) through explicit information provided by the viewer; (ii) through passive information, wherein the system observes what the viewer is watching and automatically develops a profile; (iii) through collaborative filtering by observing what programs others in the household have developed in their personal channel. (Such a system assumes that a back channel exists, and a server contains programs displayed in the other personal channels); and (iv) through a combination of all of the above.

The television viewer selects the personal channel by simultaneously depressing the * and # keys on wand 210, which enable the “personal channel” mode, as aforementioned. Thereafter, the list of programs available for the viewer is displayed upon the television screen. The viewer then selects a particular program that is intended for watching or recording. The tuner of the television will automatically be programmed to bring the program for viewing upon the screen, or a timer will automatically program the system to record the show on the VCR. The automatic recording of the program eliminates the burden of having to program the VCR to record a program.

In another embodiment of the present invention, the personal channel system shown in the FIGURES can be equipped with voice recognition, so that the input of information and the selection of viewing preferences can be expedited.

It will be evident to those skilled in the art that the described invention as herein presented is meant only to provide an exemplary description that is not limited to the details of the foregoing illustrative embodiments, and that the present invention may be embodied in other specific forms without departing from the true spirit or scope of the invention as claimed.

Having thus described the invention, what is desired to be protected by Letters Patent, is presented in the subsequently appended claims.

What is claimed is:

1. A television system comprising a display having an interactive interface for displaying a personal channel for the television viewer, said display being controllable by a computer through a remote control to invoke a personal channel featuring selective programs for an individual television viewer, said selective programs being programmed into said personal channel of said television system by at least one of the following techniques: (i) through explicit information provided by the television viewer; (ii) through passive information, wherein the system observes what the television viewer is watching and automatically develops a profile; (iii) through collaborative filtering by observing what programs others in a household of the television viewer have developed in their personal channel; and (iv) through a combination of all of the above.

2. The television system in accordance with claim 1, wherein said remote control has means for scrolling about said display.

3. The television system in accordance with claim 1, wherein said remote control has means for controlling the splitting of the display.

4. The television system in accordance with claim 1, wherein said remote control has means for controlling the recording of a television program.

5. A television system comprising a display having an interactive interface for displaying a personal channel for each member in a household of a television viewer, said display being controllable by a computer through a remote control to invoke said personal channels featuring selective programs for each individual television viewer, said selective programs being programmed into said personal channel of said television system by at least one of the following techniques: (i) through explicit information provided by each television viewer; and (ii) through passive information wherein the system observes what each television viewer is watching and automatically develops a profile.

6. The television system in accordance with claim 5, wherein said remote control has means for scrolling about said display.

7. The television system in accordance with claim 5, wherein said remote control has means for controlling the splitting of the display.

8. The television system in accordance with claim 5, wherein said remote control has means for controlling the recording of a television program.
